(19) United States
(12) Patent Application Publication
(10) Pub. No.: US 2017/0124654 A1
(43) Pub. Date: May 4, 2017

(54) Method and System for Visualising Financial Allocation Models

(71) Applicant: IBIS Information Systems PTY LTD, Melbourne (AU)

(72) Inventor: Nigel Hughes, Melbourne (AU)

(21) Appl. No.: 15/312,596

(22) PCT Filed: May 21, 2015
(86) PCT No.: PCT/IB15/53725

§ 371 Date: Nov. 18, 2016

(30) Foreign Application Priority Data
May 21, 2014 (AU) 2014901895

(51) Int. Cl. G06Q 40/06

(52) U.S. Cl. CPC G06Q 40/06

(57) ABSTRACT

A method, comprising: receiving, by a processor, numerical values relating to financial objects in a financial allocation model; receiving, by the processor, allocative functions relating to the financial objects, wherein the allocative functions allocate the numerical values away from one financial object to accumulate at another financial object; generating, by the processor, an interactive visual representation of the financial allocation model, wherein the financial objects are visually represented as nodes, and the allocative functions are visually represented as links connecting different nodes.

### FIELD

The present invention relates to a system and method for visualising financial allocation models.

### BACKGROUND

Financial allocation models, such as revenue and/or cost allocation models, are conventionally generated using spreadsheet-based financial models, such as Excel spreadsheets. Spreadsheet-based financial modeling has various disadvantages. For example, discovering relationships between different financial objects, and determining financial allocations between them, are complicated and obscured by fixed rows and columns of data. Further, financial allocations between different financial objects are statically determined by hidden allocation formulae or rules.

In this context, a need exists for visualising financial allocation models.

### SUMMARY

According to the present invention, there is provided a method, comprising:

receiving, by a processor, numerical values relating to financial objects in a financial allocation model;

receiving, by the processor, allocative functions relating to the financial objects, wherein the allocative functions allocate the numerical values away from one financial object to accumulate at another financial object;

generating, by the processor, an interactive visual representation of the financial allocation model, wherein the financial objects are visually represented as nodes, and the allocative functions are visually represented as links connecting different nodes.

The financial objects may be revenue objects or cost objects.

The financial allocation model may be a revenue allocation model, a cost allocation model, a revenue recovery allocation model, a cost recovery allocation model, a tax allocation model, an income allocation model, a financing allocation model, a profit allocation model, a funding allocation model, a budget allocation model, or a combination thereof. For example, the financial allocation model may be a revenue recovery allocation model of a local government or a municipal council.

The allocative functions may be allocation calculations, allocation rules, allocation algorithms, allocation policies, or combinations thereof. For example, the allocative functions may be percentage allocations, weighted allocations, weighted percentage allocations, or combinations thereof.

The interactive visual representation of the financial allocation model may be a node-link graph or a network flow diagram.

The method may further comprise generating, by the processor, user interfaces to enable a user to enter and manipulate the numerical values and the allocative functions of the financial objects.

Each node may be visually represented as first and second boxes, wherein the first box visually represents the financial object and the second box visually represents the accumulated numerical value at the node.

The present invention also provides a system, comprising:

a processor;

a memory coupled to the processor; and

instructions stored in the memory that, when executed by the processor, cause the processor to:
receive numerical values relating to financial objects in a financial allocation model;
receive allocative functions relating to the financial objects, wherein the allocative functions allocate the numerical values away from one financial object to accumulate at another financial object;
generate an interactive visual representation of the financial allocation model, wherein the financial objects are visually represented as nodes, and the allocative functions are visually represented as links connecting different nodes.

The present invention further provides a computer program product comprising computer executable program code recorded on a computer readable non-transitory storage medium, the computer executable program code comprising:

code for receiving numerical values relating to financial objects in a financial allocation model;

code for receiving allocative functions relating to the financial objects, wherein the allocative functions allocate the numerical values away from one financial object to accumulate at another financial object;

code for generating an interactive visual representation of the financial allocation model, wherein the financial objects are visually represented as nodes, and the allocative functions are visually represented as links connecting different nodes.

### BRIEF DESCRIPTION OF DRAWINGS

Embodiments of the invention will now be described by way of example only with reference to the accompanying drawings, in which:

FIG. 1 is a flowchart of a computer-implemented method for visualising financial allocation models according to an embodiment of the invention;

FIG. 2 is a schematic diagram of a visual representation of a financial allocation model used by the method;

FIGS. 3 to 5 and 7 to 10 are interactive user interfaces generated by the method; and

FIGS. 6 and 11 are visual representations of financial allocation models generated by the method.

### DETAILED DESCRIPTION

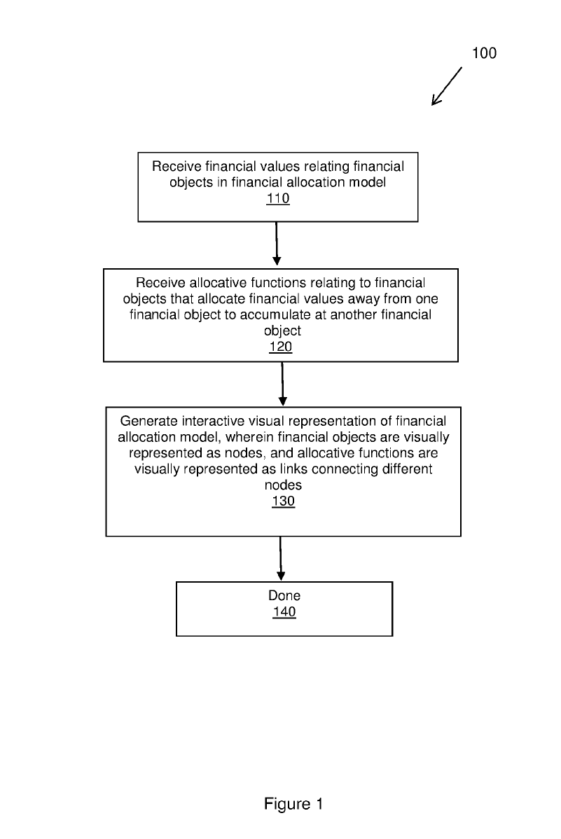

FIG. 1 is a flowchart of a method 100 for visualising financial allocation models according to an embodiment of the invention. The method 100 may be implemented by a computing device comprising one or more processors and one or more storage devices. The processor(s) and storage device(s) may be provided in a dedicated computing device, or distributed among computing devices and/or a cloud-based processing and storage platform. The computing device may comprise a desktop computer, a laptop computer, a tablet, or a smartphone.

The functionality of the method 100 may be embodied in processor-executable instructions stored in the storage device and executable by the processor to perform operations corresponding to the method steps. The instructions may comprise one or more software modules of a software application. The software application may be a desktop application, a web application, a mobile application, or a combination thereof.

The method 100 starts at step 110 by receiving, by a processor, numerical values relating to financial objects of a financial allocation model. The financial objects may be revenue objects or cost objects. The financial allocation model may be a revenue allocation model, a cost allocation model, a revenue recovery allocation model, a cost recovery allocation model, a tax allocation model, an income allocation model, a financing allocation model, a profit allocation model, a funding allocation model, a budget allocation model, or a combination thereof. For example, the financial allocation model may be a revenue recovery allocation model of a local government or a municipal council. Other equivalent or alternative financial objects and financial allocation models may also be used.

The method 100 moves to step 120 where the processor receives allocative functions relating to the financial objects. The allocative functions may allocate the numerical values away from one financial object to accumulate at another financial object. The allocative functions may be allocation calculations, allocation rules, allocation algorithms, allocation policies, or combinations thereof. For example, the allocative functions may be percentage allocations (or “splits”), weighted allocations, weighted percentage allocations, or combinations thereof. Other equivalent or alternative allocative functions may also be used.

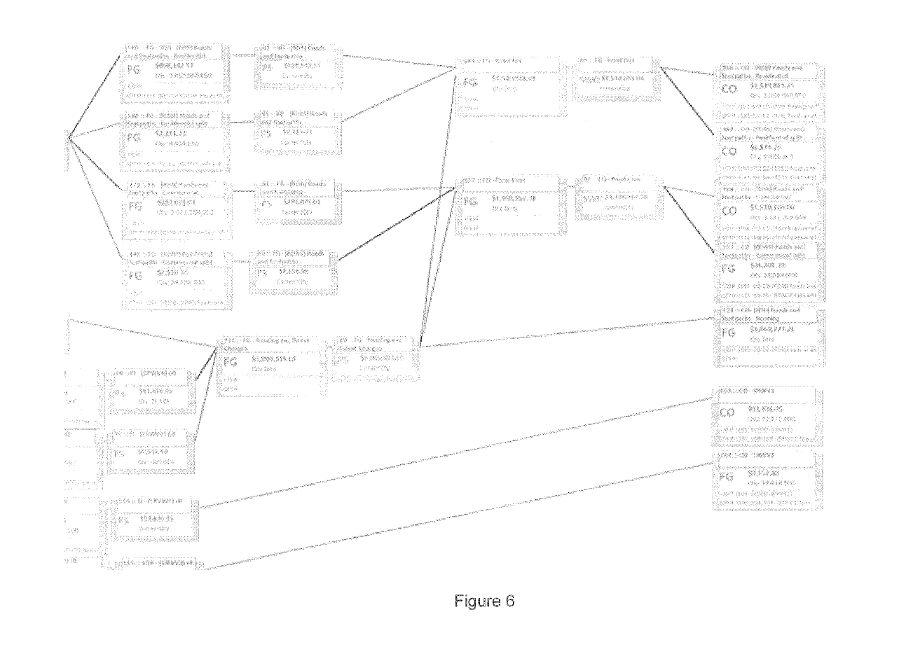

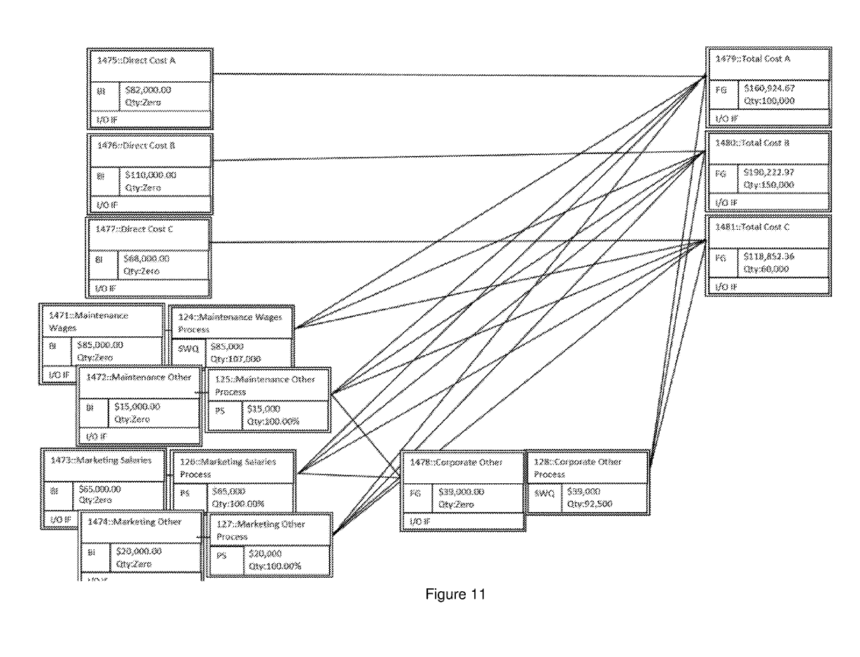

At step 130, the processor generates an interactive visual representation of the financial allocation model. Referring to FIGS. 6 and 11, the financial objects may be visually represented as nodes, and the allocative functions may be visually represented as links connecting different nodes. The interactive visual representation of the financial allocation model may be a node-link graph or a network flow diagram. Each node in the node-link graph or network flow diagram may be visually represented as first and second boxes. The first box may visually represent the financial object, and the second box may visually represent the accumulated numerical value at each node. Other equivalent interactive visual representations of financial allocation models may also be used. The method 100 is done at step 140.

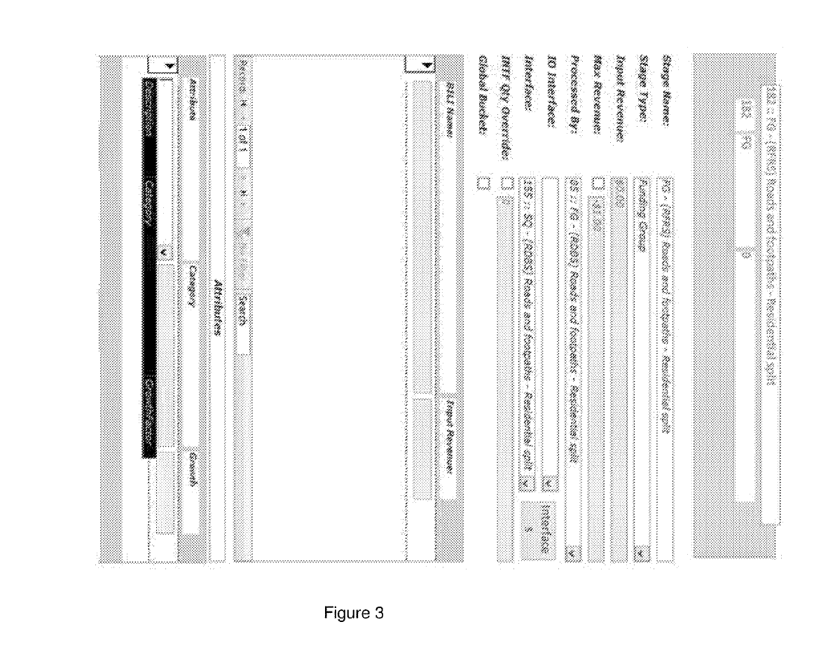

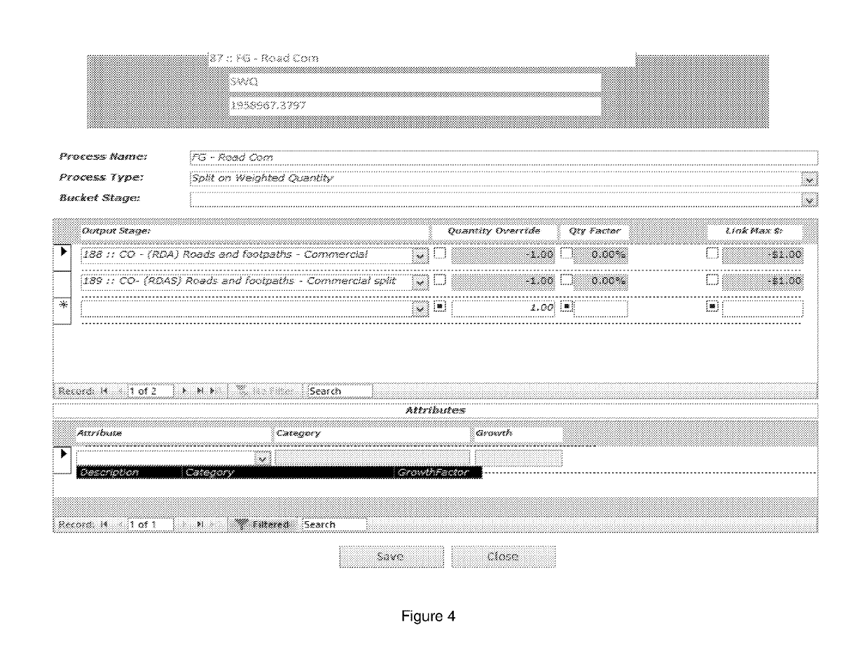

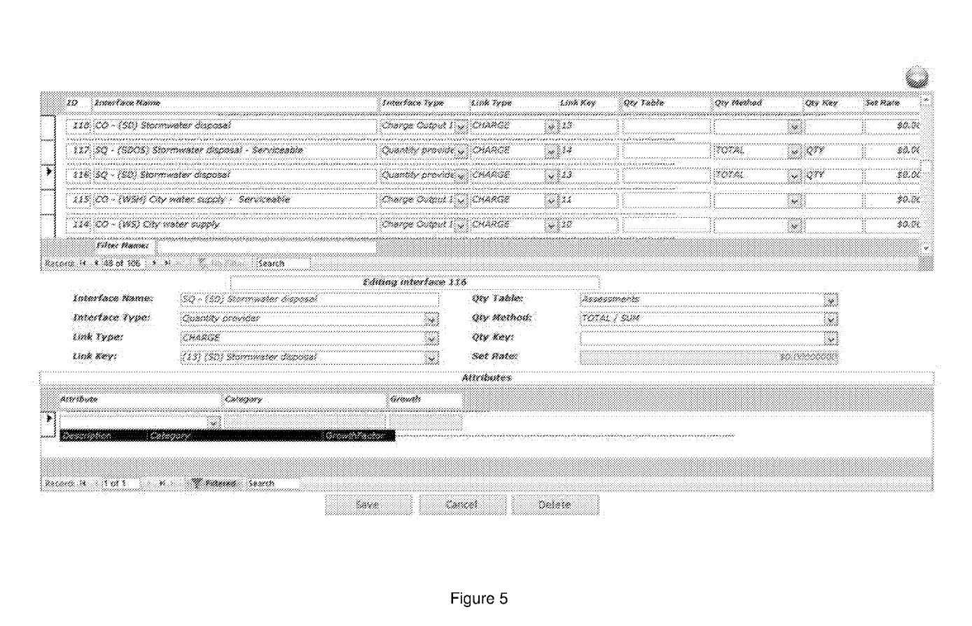

The method 100 may further comprise generating, by the processor, user interfaces to enable a user to enter and manipulate the numerical values and the allocative functions of the financial objects. FIG. 3 illustrates an interactive user interface for receiving numerical values relating to financial objects. FIGS. 4, 7 and 9 illustrate interactive user interfaces for receiving allocative functions for the numerical values of the financial objects. FIG. 5 illustrates an interactive user interface summarising a financial object and its corresponding numerical values and allocative functions. Other equivalent or alternative interactive user interfaces may also be used.

The invention will now be described in more detail, by way of illustration only, with respect to the following examples. The examples are intended to serve to illustrate this invention, and should not be construed as limiting the generality of the disclosure of the description throughout this specification.

### EXAMPLE 1

### Revenue Recovery Allocation Model

In this example, the financial model relates to funding allocations and revenue recovery allocations by an enterprise. The example involves generating a visual representation of relationships and corresponding accumulated financial flows among financial activities, decisions and beneficiaries of an enterprise that provide benefits to beneficiaries. The enterprise may comprise a public enterprise, a private enterprise or a hybrid public/private enterprise. For example, the enterprise may be a local government or a municipal council. The activities provided by the enterprise may comprise providing technical services (such as waste collection, animal control and building inspections), utilities (such as water, sewage, gas and electricity) and infrastructure (such as roads, footpaths, bridges, ports and airports), or financing (such as home insulation schemes). The beneficiaries (or funding groups) of the activities may comprise direct or indirect recipients of the technical service or the utility, or users of the infrastructure. For example, when the enterprise is a local council, the beneficiaries may be different types or classes of ratepayers, such as residential, commercial, educational, forestry, winery, investment property, manufacturing, logistics and farming ratepayers. For example, when the enterprise is a water authority, types or classes of beneficiaries may include residential or commercial beneficiaries, potable water, sewer, or trade waste services. Other equivalent or alternative classes of beneficiaries may also be used.

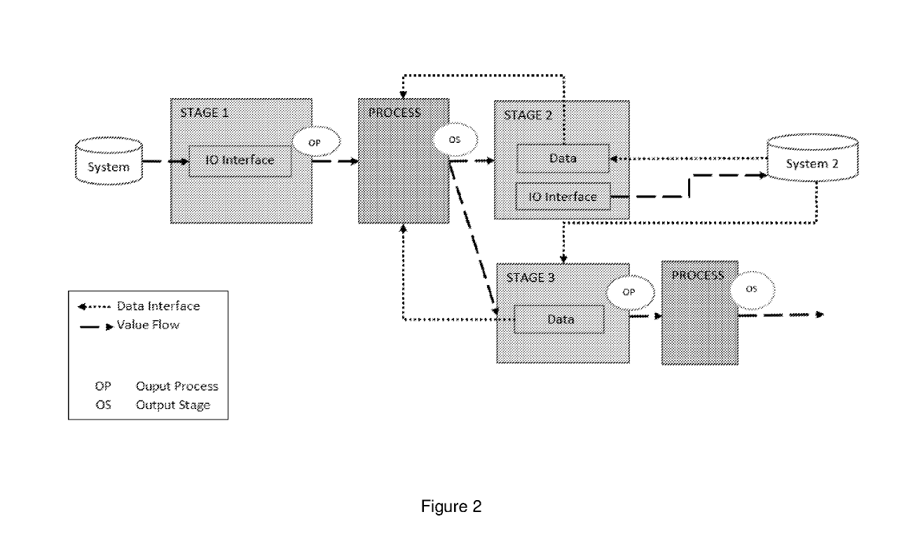

Referring to FIG. 2, the visual representation of the revenue recovery allocation model may comprise a node-link graph comprising a network of nodes and corresponding links. The nodes of the graph may comprise the fixed parts of the network, while the links may comprise the dynamic parts, or the “financial flows”. The activities, decisions and beneficiaries may be visually represented by the nodes, and the relationships and corresponding financial flows among the activities and the beneficiaries may be visually represented by links between the nodes. The links may further visually represent flows of data or values to or from separate calculation modules or software systems via input/output (IO) data interfaces or data driver interfaces. For example, the visual representation illustrated in FIG. 6 visually maps relationships and corresponding financial flows of funding among council activities of providing and maintaining roads and footpaths for residential, commercial and farming ratepayers.

Referring again to FIG. 2, the nodes visually representing the activities, decisions and beneficiaries in the visual representation of the revenue recovery allocation model may comprise sequential allocative functions (or “Processes”) and one or more related financial objects (or “Stages”). Numerical values and quantities may accumulate at the Stages, while calculation and input/output of numerical values and quantities relating to the Stages may be performed at the one or more related Processes. The numerical values and quantities accumulated at the Stages, and the calculation on numerical values and quantities is performed at the Processes. This may be received or displayed via interactive user interfaces associated with or displayed on the visual representation of the revenue recovery allocation model. The user interfaces may, for example, comprise table user interfaces, user-selectable list boxes, dialog boxes, formula edit boxes, etc. FIG. 3 is illustrates an example user interface associated with a Stage node, while FIG. 4 illustrates an example user interface associated with a Process node. FIG. 5 illustrates an example user interface summarising the Stage and Process nodes. The visual representation of the revenue recovery allocation model illustrated in FIG. 6 shows a sequential left-to-right sequential series of Stage and interlinked Process nodes associated with council activities of providing and maintaining roads and footpaths for residential, commercial and farming ratepayers.

As illustrated in FIG. 2, once a visual representation of the revenue recovery allocation model is designed, the calculation mechanism represented by the allocative functions journeys through the network to populate the processes with the data required to calculate the allocations or splits, and then calculate values as the allocations or splits are applied to the values cascading through the visual representation. In one embodiment, the visual network model has two types of nodes, namely Stages and Processes. All nodes have an input link and an output link to other nodes in the network (unless the node is a zero node or an output node). The nodes are sequenced so that a Process always follows and is between successive Stages. Stages function operationally as an accumulator. They represent places in the network where numerical values and quantities accumulate. A Stage may be associated with two different types of interfaces, either a link input/results interface (IO interface) or a data driver interface to map data from separate software systems. A Stage output can only link to a single Process, but may have multiple Process inputs.

The main function of a Process is to use allocative functions or rules to process, transform or calculate incoming numerical data, and to facilitate the communication (or accumulative flow on effects) of numerical results through the network. The Process holds configuration that drives the processing of data through Stages of the network. A Process can have many to many relationships on both input and output sides to Stages. The arrows represent cascading accumulated financial flow for value (left to right), backchannel (or feedback) effects of the interfaces such as a Process consuming the quantity (driver) of the output to Stages that are defined in this Process, and mapping interfaces to other financial systems, such as Systems 1 and 2. The user interface provides the capability to manage the positioning of the above entities and ensures the above sequence of nodes is strictly enforced. Additional functionality is provided to maintain alignment of financial objects. The network may be displayed, manipulated and managed through a paging feature as subsets of Stages and Processes. As previously described, once a visual network flow model is determined by a user, the accumulated numerical values calculated by the calculation mechanism of the method journey through the network, populating the Processes with the data required to calculate the allocations or splits, followed by values being calculated through the network. For example, in the context of a council, the method takes the input/imported value and allocates based on the rules and the quantities received from the property set imported from the separate rates management software. The method calculates the revenue required to be levied by each charge, and outputs this to the rates management software to allow for rates impact analysis to be undertaken.

Referring again to FIG. 2, one or more of the Stage nodes may be linked or interfaced via link input/results interfaces (IO) interfaces to one or more Systems, such as separate calculation modules, software systems or analytical models. The link IO interfaces may enable data at each Stage to be defined in or mapped to tables in separate software systems, such as rates modeling software or an Excel range object. In addition, data driver interfaces may perform driver interface tasks, such as retrieving data from an associated software system at run-time. This functionality may allow for a fully featured dynamic allocation model to work in that as the data in the interfaced system changes or is updated automatically, and they are immediately reflected in the financial allocation model without further user intervention. The method may therefore have the capability to manage the interdependence of a network and the impact of subsequent interface values. For example, in a council application, one of the Process types uses a data interface to evaluate eligibility; ie, if the property has this attribute, or has this charge, apply this allocation calculation algorithm.

The link IO interfaces may map to values for inputs, and maps outputs to a table within the interfaced System. For example, at the top left stage in FIG. 2, a budget activity input value is retrieved from system 1 via a link IO interface. The subsequent Process splits the stage based on the capital value provided by the data driver interface of the linked output Stages. The top right Stage then outputs the value to System 2 via a link IO interface. The arrows between the Stages and Processes, and the corresponding link IO interfaces and data/driver interfaces, indicate data flows that in turn determine value flows through the visual network model. As such, the visual network model provides a dynamic allocation system that reflects changes in input values and changes in real world data. The visual network model represents a network of financial allocation rules and accumulated financial flows represented as nodes (functional objects) with lines as links depicting the relationship between nodes.

The funding allocation decisions among beneficiaries of the activities may be received based on the visual network model. The funding allocation decisions may comprise funding allocation decisions based on funding allocation rules, policies or data, for example, council rates rules or policies. The funding allocation rules or policies corresponding to the activities may be displayed via the user interfaces associated with or displayed on the visual network model. The funding allocation rules or policies may be represented by funding allocation algorithms. The funding allocation decisions may be received via the user interfaces and summarised on the visual network model. For example, the funding allocation decisions may be based on funding allocation algorithms that comprise splitting percentage funding allocations among different classes of the beneficiaries of the activities (ie, among different funding groups of beneficiaries). For example, when the beneficiaries are council ratepayers, the funding allocation decisions may comprise fixed percentage allocations among different classes of ratepayers. The funding allocations decisions may also comprise other allocations based on dynamic (ie, non-fixed percentage) funding allocation algorithms, weightings, logic, or mathematical operations.

The revenue recovery allocations among the beneficiaries of the activities may be quantitatively determined based on the corresponding funding flows and funding allocation decisions. The revenue recovery allocations may be based at least in part on revenue recovery algorithms. The revenue recovery allocations may comprise one or more of a rate, a subscription, a tariff, a tax, a levy, a toll, a usage fee, and a utility charge. The revenue recovery allocations may comprise different revenue recovery allocations among different classes of the beneficiaries, or revenue recovery allocations to specific details for each individual beneficiary.

Referring again to FIG. 6, the revenue recovery allocations among residential, commercial and farming ratepayers may be quantitatively determined based on the funding flows between the stages and processes associated with the council activities of providing roads and footpaths. The quantitative revenue recovery allocations for roads and footpaths among residential, commercial and farming ratepayers are displayed in the output Stage on the right hand side of the visual network model of FIG. 6. The different rate recovery allocations may also be provided in a revenue recovery report, for example, one of a rates impact analysis, a funding impact statement, a financial forecast and a budget. For example, the revenue recovery report may comprise or add context to rates impact analyses, funding impact statements, financial forecasts or budgets.

The above example has been described with reference to local governments or municipal councils as example enterprises. It will be appreciated that embodiments of the present invention are not limited to financial allocation models of public enterprises, assets or infrastructure, but may be alternatively implemented for private and hybrid public/private enterprises, assets or infrastructure.

### EXAMPLE 2

### Product Cost Allocation

In this example, the financial allocation model may be a product cost allocation model visually represented in FIG. 11. The financial objects of the product cost allocation model may be cost objects (or “Stages”). The cost objects may be direct costs, and indirect costs of “Maintenance”, “Marketing” and “Corporate Other”. The cost objects may have corresponding allocative functions (or “Processes”). The allocative functions may be either fixed percentage allocations, or weighted allocations based on the quantity (or “Qty Factor”) of each manufactured product. Each node of the product cost allocation model may be visually represented by first and second boxes. The first box may visually represent a Stage, and the second box may visually represent the accumulated financial value at that node. The accumulated financial value at each node is calculated using a linked Process which allocates numerical values away from one Stage to accumulate at another Stage.

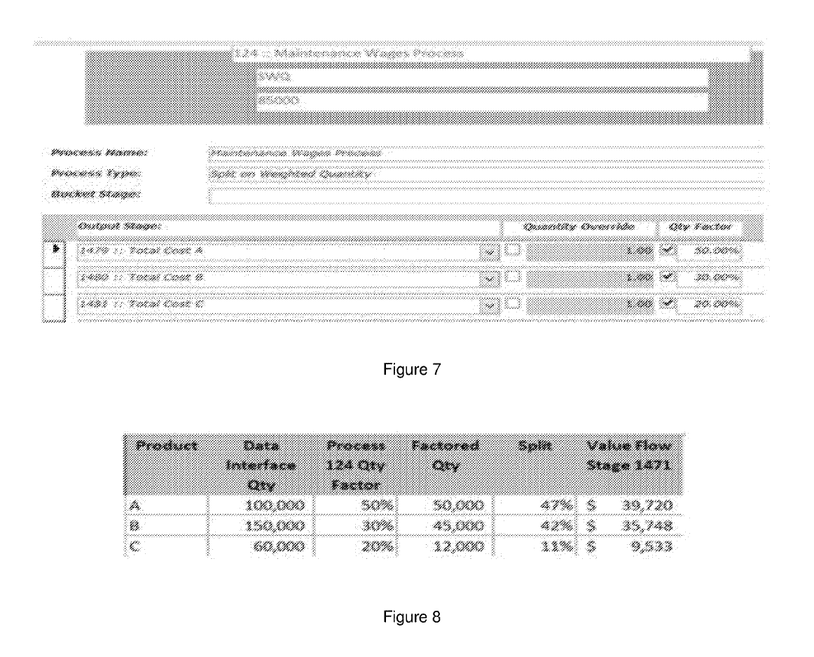

For example, Stages 1475 to 1477 receive the “Direct Costs” of manufacturing for each product. These flow directly to the “Total Cost Stages” (no further allocations) to each “Product Total Stage” 1479 to 1481. Process 124 “Maintenance Wages” allocates the accumulated numerical values to Stage 1471, calculating a weighted percentage split by applying the “Qty Factor” entered to the quantity received via the user interface illustrated in FIG. 7. FIG. 8 illustrates the allocation calculations automatically performed on the input quantities using the “Factored Qty” and “Split” received via the user interface of FIG. 7.

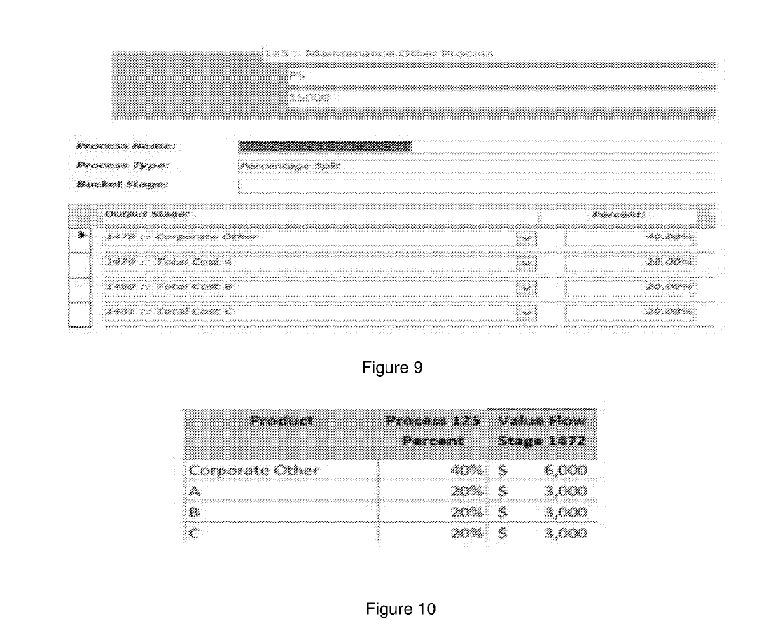

Stage 1478 “Corporate Other” receives in addition to the $25,000 from System 1, allocations from process 125 “Maintenance Other” and process 127 “Marketing Other”. FIG. 9 illustrates the user interface for Process 125, showing the “Percent” to be applied to the linked Output Stages. FIG. 10 illustrates the allocation calculations automatically performed for Process 125. Stages 1479 to 1481 are the resultant accumulated total cost of the direct costs, plus the allocation of the indirect costs of “Maintenance”, “Marketing” and “Corporate Other”.

Embodiments of the present invention usefully enable visualisation of financial allocation models.

For the purpose of this specification, the word “comprising” means “including but not limited to”, and the word “comprises” has a corresponding meaning.

The above embodiments have been described by way of example only and modifications are possible within the scope of the claims that follow.

1. A method, comprising:
receiving, by a processor, numerical values relating to financial objects in a financial allocation model;
receiving, by the processor, allocative functions relating to the financial objects, wherein the allocative functions allocate the numerical values away from one financial object to accumulate at another financial object;
generating, by the processor, an interactive visual representation of the financial allocation model, wherein the financial objects are visually represented as nodes, and the allocative functions are visually represented as links connecting different nodes.

2. The method of claim 1, wherein the financial objects are revenue objects or cost objects.

3. The method of claim 1, wherein the financial allocation model is a revenue allocation model, a cost allocation model, a revenue recovery allocation model, a cost recovery allocation model, a tax allocation model, an income allocation model, a financing allocation model, a profit allocation model, a funding allocation model, a budget allocation model, or a combination thereof.

4. The method of claim 3, wherein the financial allocation model is a revenue recovery allocation model of a local government or a municipal council.

5. The method of claim 1, wherein the allocative functions are allocation calculations, allocation rules, allocation algorithms, allocation policies, or combinations thereof.

6. The method of claim 5, wherein the allocative functions are percentage allocations, weighted allocations, percentage weighted allocations, or combinations thereof.

7. The method of claim 1, wherein the interactive visual representation of the financial allocation model is a node-link graph or a network flow diagram.

8. The method of claim 1, further comprising generating, by the processor, user interfaces to enable a user to enter and manipulate the numerical values and the allocative functions of the financial objects.

9. The method of claim 1, wherein each node is visually represented as first and second boxes, and wherein the first box visually represents the financial object and the second box visually represents the accumulated numerical value at the node.

10. A system, comprising:
a processor;
a memory coupled to the processor; and
instructions stored in the memory that, when executed by the processor, cause the processor to:
receive numerical values relating to financial objects in a financial allocation model;
receive allocative functions relating to the financial objects, wherein the allocative functions allocate the numerical values away from one financial object to accumulate at another financial object;
generate an interactive visual representation of the financial allocation model, wherein the financial objects are visually represented as nodes, and the allocative functions are visually represented as links connecting different nodes.

11. A computer program product comprising computer executable program code recorded on a computer readable non-transitory storage medium, the computer executable program code comprising:
code for receiving numerical values relating to financial objects in a financial allocation model;
code for receiving allocative functions relating to the financial objects, wherein the allocative functions allocate the numerical values away from one financial object to accumulate at another financial object;
code for generating an interactive visual representation of the financial allocation model, wherein the financial objects are visually represented as nodes, and the allocative functions are visually represented as links connecting different nodes.
